(19) United States
(12) Patent Application Publication
(10) Pub. No.: US 2010/0166531 A1
(43) Pub. Date: Jul. 1, 2010

(54) TIRE MANIPULATOR AND PERSONNEL SAFETY DEVICE

(75) Inventors: Karl James Bauer, Garner, IA (US); Bradley Gayle Ethington, Rudd, IA (US)

Correspondence Address: FOLEY & LARDNER LLP, 777 EAST WISCONSIN AVENUE, MILWAUKEE, WI, 53202-5306, US

(73) Assignee: Oshkosh Corporation

(21) Appl. No.: 12/346,415

(22) Filed: Dec. 30, 2008

(51) Int. Cl. B60B 29/00; B66F 9/12

(52) U.S. Cl. 414/429; 187/237

(57) ABSTRACT

A tire manipulator includes a base, first and second extensions coupled to the base and configured to support a tire, each of the first and second extensions including a first end coupled to the base and a second end configured to support the tire, and first and second supports movably coupled to the first and second extensions, respectively, the first and second supports being disposed between the first and second end of each of the first and second extensions. The first and second supports may be positionable to prevent the tire from rotating relative to the first and second extensions toward the base.

### BACKGROUND

The present disclosure relates generally to the field of tire manipulators or tire handlers used to handle large-sized tires for vehicles, and personnel safety devices intended to ensure the safety of personnel handling such tires. More specifically, the present disclosure relates to a tire manipulator that includes one or more fall-back arms or supports.

Large vehicles such as mining trucks, excavation vehicles, etc. often utilize large tires because of the size of the vehicles and heavy loads often handled by such vehicles. Tires for these vehicles are often too large to be handled (e.g., changed, repaired, etc.) safely and efficiently without the use of specialized devices that are designed to handle larger-sized tires. Such specialized devices are often referred to as tire manipulators or tire handlers. Tire manipulators may be mounted to a vehicle such as a loader truck, lift truck, or similar vehicle, and may be used in the changing and/or maintenance, etc. of large tires.

However, conventional tire manipulators have several disadvantages with respect to maintaining the safety of the operator of the tire manipulator and others involved in the changing and maintenance of tires, and further with respect to avoiding damage to the tire and other items during usage of the tire manipulator.

Accordingly, it would be advantageous to provide an improved tire manipulator that overcomes the disadvantages found in may conventional tire manipulators.

### SUMMARY

One embodiment relates to a tire manipulator comprising a base, first and second extensions coupled to the base and configured to support a tire, each of the first and second extensions including a first end coupled to the body and a second end configured to support the tire, and first and second supports movably coupled to the first and second extensions, respectively, the first and second supports being disposed between the first and second end of each of the first and second extensions, wherein the first and second supports are positionable to prevent the tire from rotating relative to the first and second extensions toward the body.

Another embodiment relates to a tire manipulator comprising a body and first and second extensions coupled to the body and configured to support a tire, the tire having a treaded portion and a sidewall extending from the treaded portion, each of the first and second extensions including an arm member coupled to the body, a hand member coupled to the arm member, a clamping member extending from the hand member and configured to engage the treaded portion of the tire, and a fall-back support coupled to the hand member and configurable to extend from the hand member to engage the sidewall and prevent rotation of the tire toward the body.

Another embodiment relates to a maintenance vehicle comprising a vehicle body and a tire manipulator coupled to the vehicle body and configured to manipulate a tire, the tire manipulator including a body portion, a pair of extensions extending from the body, each extension including a gripping surface configured to engage a surface of the tire, and a pair of fall-back supports disposed between the body and the tire and positionable to prevent the tire from rotating toward the body portion in the event of slippage between the gripping surfaces and the surface of the tire.

### BRIEF DESCRIPTION OF THE DRAWINGS

FIG. 1 is a perspective view of a vehicle equipped with a tire manipulator according to an exemplary embodiment.

FIG. 2 is a perspective view of the tire manipulator shown in FIG. 1 according to an exemplary embodiment.

FIG. 3 is a top view of a tire manipulator according to an exemplary embodiment.

FIG. 4 is a perspective view of a tire manipulator and tire according to an exemplary embodiment.

FIG. 5 is a side view of the tire manipulator and tire of FIG. 4 according to an exemplary embodiment.

FIG. 6 is a partially exploded perspective view of a tire manipulator showing a support in both a deployed and stowed position according to an exemplary embodiment.

FIG. 7 is an exploded view of a portion of a support according to an exemplary embodiment.

### DETAILED DESCRIPTION OF EXEMPLARY EMBODIMENTS

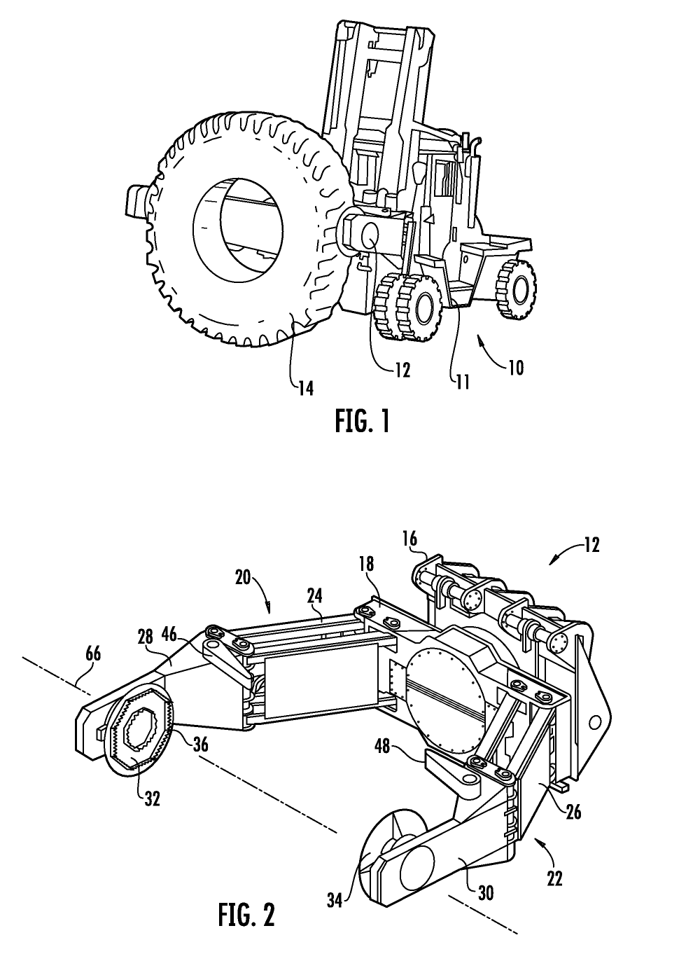

Referring to FIG. 1, a vehicle 10 is shown according to an exemplary embodiment and includes a vehicle body 11 coupled to a tire manipulator 12 (e.g., a tire handler, a tire lifter, etc.). As shown in FIG. 1, tire manipulator 12 is configured to support (e.g., grasp, lift, secure, etc.) a tire 14. While vehicle 10 shown in FIG. 1 is shown as a lift truck, vehicle 10 may be any of a variety of vehicles capable of supporting tire manipulator 12 and tire 14, including other types of trucks or maintenance vehicles such as loader trucks, etc. Furthermore, tire manipulator 12 may be coupled to vehicle body 11 via in intermediate support member such as a coupler 16 shown in FIG. 2. In various alternative embodiments, rather than tire manipulator 12 being coupled to a vehicle such as vehicle 11, tire manipulator 12 may be coupled to a number of other maintenance devices, such as articulated cranes and so on.

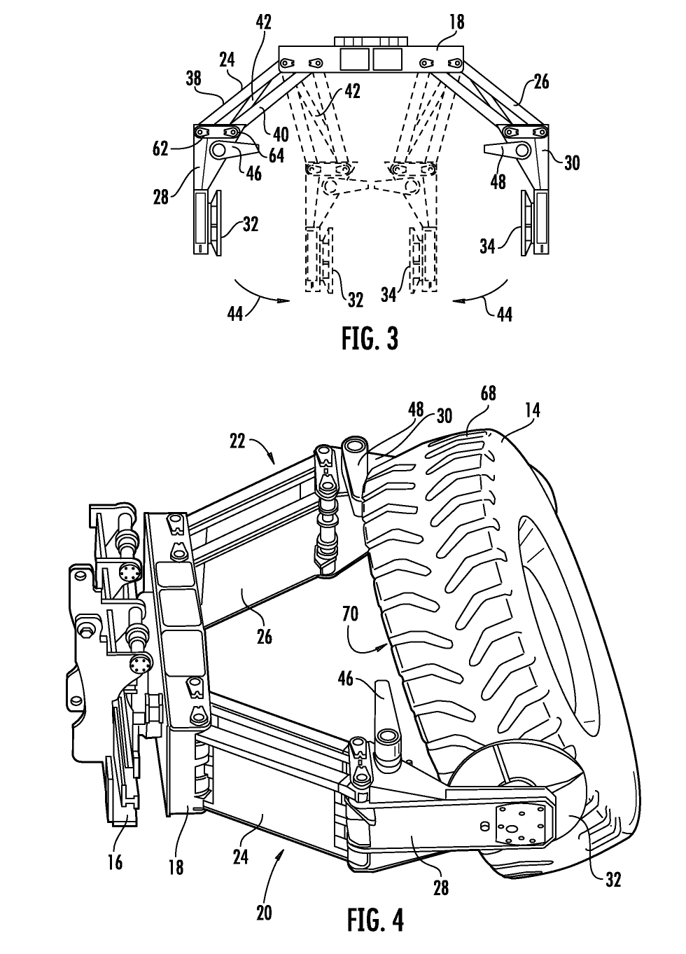

Referring to FIGS. 2 and 3, tire manipulator 12 is shown in greater detail according to an exemplary embodiment. As shown in FIG. 2, tire manipulator 12 may include a coupling member or coupler 16 (e.g., a coupling member, mounting member, interface, etc.) and a base or body 18 (e.g., a body portion, a base, etc.). Tire manipulator 12 is coupled to vehicle body 11 via coupler 16. Body 18 and/or coupler 16 may provide or assist in providing translational and/or rotational movement of tire manipulator 12 relative to vehicle body 11 using conventional means such as hydraulic and/or electrical control systems. According to an exemplary embodiment, tire manipulator 12 may include a pair of extensions 20, 22 (e.g., support members or portions, extending members, etc.). Each extension 20, 22 may include a first portion or arm 24, 26 (e.g., a first or arm member or extension, etc.), and a second portion or hand 28, 30 (e.g., a second or hand member or extension). Arms 24, 26 may be movably coupled to body 18 at one end such that arms 24, 26 may rotate relative to body 18 (e.g., as shown in FIG. 3). According to an exemplary embodiment, arms 24, 26 may include multiple individual linkages such that each of arms 24, 26 forms a parallelogram throughout the range of motion of arms 24, 26. Hands 28, 30 may be coupled to arms 24, 26, respectively, and according to one embodiment, may move in a substantially parallel fashion relative to one another, as illustrated in FIG. 3.

According to an exemplary embodiment, tire manipulator 12 may include clamping members or pads 32, 34 (e.g., gripping pads or members, clamping portions, claws, etc.) that extend toward each other from hands 28, 30 and are configured to securely hold a tire such as tire 14. Clamping members 32, 34 may be provided with gripping surfaces 36 (e.g., projections, bumps, spikes, gripping members, etc.) intended to ensure a secure grasp of a tire such as tire 14 and prevent rotation of tire 14 relative to gripping surface 36. Gripping surfaces 36 may include bumps, ridges, spikes, or any other suitable surface configuration suitable to grasp a tire such as tire 14. Clamping members 32, 34 may be configured to be rotatable relative to hands 28, 30 (e.g., such that clamping members 32, 34 and tire 14 may be rotated about axis 66 shown in FIG. 2) in order to facilitate manipulation of tire 14. Movement of clamping members 32, 34 may be controlled mechanically, hydraulically, electronically, or by any other suitable method or combination thereof.

Referring further to FIG. 3, tire manipulator 12 is shown in two different positions according to an exemplary embodiment, and may be moved between a relatively wider configuration and a relatively narrower configuration along paths 44. As shown in FIG. 3, arms 24, 26 may be coupled to hands 28, 30 via mounting locations 62, 64, which may be configured to receive a variety of fasteners such as pins, screws, or other fasteners. As discussed above, arms 24, 26 may include multiple linkages that form a parallelogram through the range of motion of arms 24, 26. As a result of this parallelogram feature, mounting locations 62, 64 remain substantially parallel to the face of body 18 through the range of motion of arms 24, 26. This in turn maintains hands 28, 30 in a substantially parallel configuration relative to each other throughout the range of motion of hands 28, 30, and facilitates the gripping and lifting of tires by keeping clamping members 32, 34 substantially parallel to each other, as shown in FIG. 3.

According to an exemplary embodiment, movement of arms 24, 26 and hands 28, 30 may result from operation of one or more cylinder mechanisms 42 shown in FIG. 3. As shown in FIG. 3, cylinder mechanism 42 may extend between opposite ends of linkages 38, 40 that form part of arm 24. Cylinder mechanism 42 may be a hydraulic cylinder that uses hydraulic fluid to actuate the cylinder and control the movement of arms 24, 26 and hands 28, 30 (e.g., between the two positions shown in FIG. 3 along path 44). According to various other embodiments, other means of controlling arms 24, 26 and hands 28, 30 may be used, including other types of cylinders, and other types of mechanical or other control devices.

Referring further to FIGS. 2 and 3, according to an exemplary embodiment, tire manipulator 12 may include one or more fall-back support members or supports 46, 48 (e.g., supports, extensions, support arms, projections, etc.). Supports 46, 48 are intended to prevent a tire such as tire 14 from rotating toward body portion 18, for example, in the event of slippage between clamping members 32, 34 and tire 14. Further, supports 46, 48 assist in maintaining tire 14 in a substantially vertical orientation (e.g., with sidewall 70 of tire 14 in a substantially vertical orientation). According to one embodiment, supports 46, 48 are fabricated from steel, although other suitable materials may be used according to various other embodiments. As shown in FIG. 2, supports 46, 48 may be generally elongated members and may have a generally rectangular cross-section. Further, supports 46, 48 may be tapered along their lengths. As shown in FIG. 2, supports 46, 48 may be positioned to extend from extensions 20, 22 between clamping members 32, 34 and body portion 18. According to an exemplary embodiment, supports 46, 48 may extend from the top surfaces of hands 28, 30. In various other embodiments, supports 46, 48 may extend from other locations, such as arms 24, 26, other surfaces of hands 28, 30 (e.g., the bottom surfaces), etc.

As shown in FIG. 3, when supports 46, 48 are deployed (e.g., in the position shown in FIG. 3) supports 46, 48 are maintained in a substantially parallel configuration relative to one another, and in turn, tire 14. This is intended to ensure that should tire 14 slip relative to clamping members 32, 34, supports 46, 48 will provide substantially equal support to tire 14 via sidewall 70. This avoids transmitting uneven loads to vehicle 10 via tire manipulator 12.

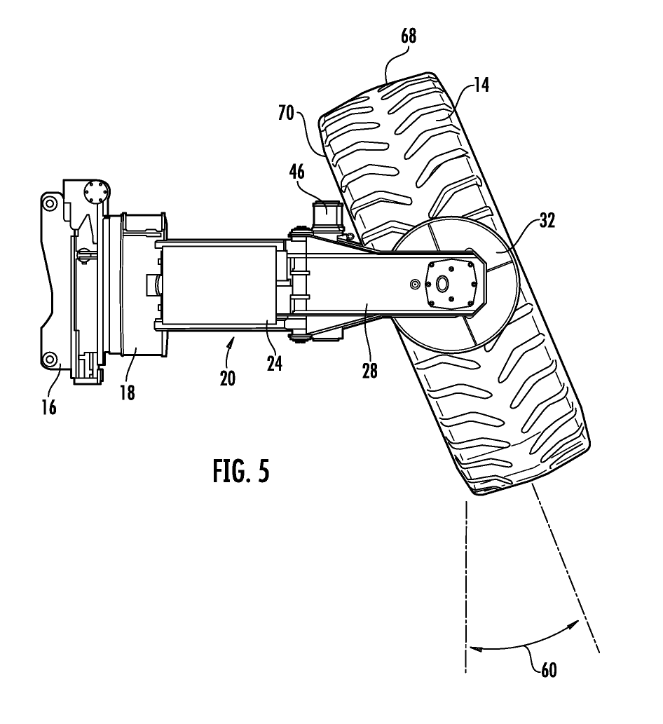

Referring to FIGS. 4 and 5, supports 46, 48 are shown in the deployed position and are positioned to prevent tire 14 from rotating toward body 18 should tire 14 slip relative to clamping members 32, 34. As shown in FIG. 4, clamping members 32, 34 engage a treaded portion 68 of tire 14, and supports 46, 48 are configured to engage a sidewall 70 of tire 14. According to some embodiments, supports 46, 48 may be positioned such that a variety of tire sizes (e.g., varying diameters and tire widths) may be accommodated by tire manipulator 12. In some embodiments, should tire 14 slip relative to clamping members 32, 34, tire 14 may be permitted to rotate a certain amount prior to supports 46, 48 engaging sidewall 70 of tire 14. For example, as shown in FIG. 5, tire 14 may rotate through an angle of rotation represented by arrow 60 (e.g., a predetermined angle such as 5 degrees, 10 degrees, 30 degrees, etc.) prior to supports 46, 48 engaging sidewall 70 of tire 14. The position of supports 46, 48 may be adjusted or otherwise configured to provide for varying sizes of tire 14 and varying angles of rotation.

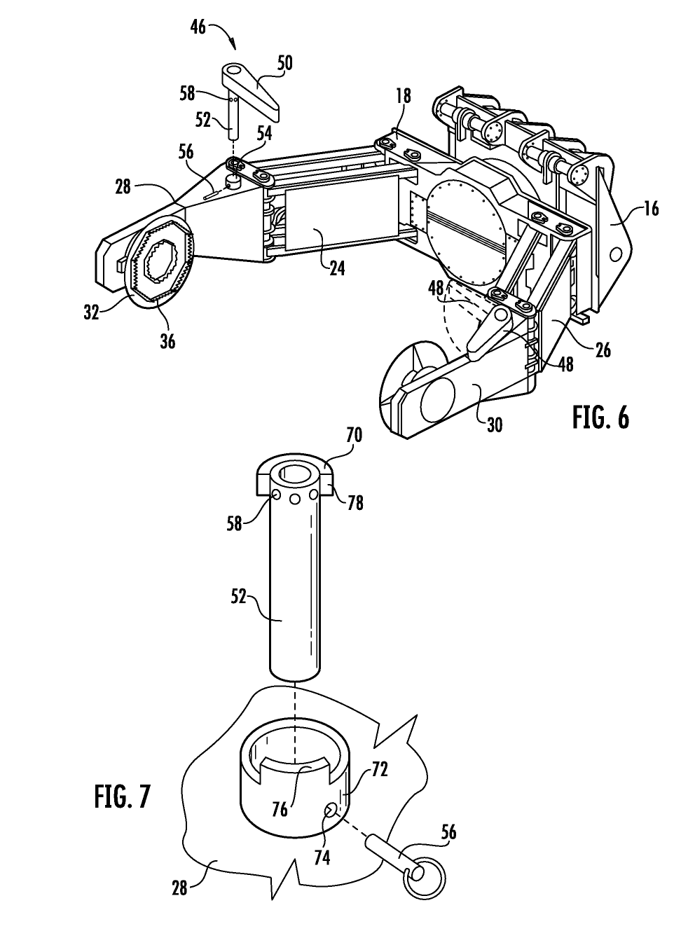

Referring now to FIG. 6, tire manipulator 12 and supports 46, 48 are shown in greater detail. As shown in FIG. 6, support 46 (and, similarly, support 48) may include a support arm 50 and an extension 52. Support arm 50 is configured to engage tire 14, and extension 52 is configured to be received within a correspondingly sized aperture 54 (e.g., a tube, recess, etc.) in hand 28. According to an exemplary embodiment, extension 52 may be a cylindrically-shaped member and be rotatable within aperture 54.

According to an exemplary embodiment, extension 52 may further include a number of apertures 58 positioned about the circumference of extension 52. Apertures 58 may be positioned such that supports 46, 48 may be locked into either a first or deployed position, or a second or stowed position, by inserting a fastener 56 (e.g., a locking pin or member, a keyed member, etc.) into one of apertures 58 when extension 52 is received within aperture 54. This locking feature maintains supports 46, 48 in a deployed position (e.g., pointing toward generally each other) should tire 14 slip and apply forces to supports 46, 48 that would otherwise tend to rotate supports 46, 48 to a stowed position, and maintains supports 46, 48 in a stowed position (e.g., generally parallel to and along a top surface of hands 28, 30) should supports 46, 48 not be required or desired (e.g., should a user wish to rotate a tire about axis 66 shown in FIG. 2).

According to an exemplary embodiment, the range of motion of extension 52 relative aperture 54 may be limited by providing corresponding keyed members such as raised portions or projections on one or both of extension 52 or the interior wall of aperture 54 (e.g., to permit rotation only through 90 degrees, 180 degrees, etc.), by using indents and/or detents, and so on. For example, hand 28 may define one or more positive steps (e.g., stepped surfaces, etc.) such that the range of motion of support 48 (and, similarly, support 46) is limited to approximately 90 degrees (e.g., an amount sufficient to permit movement of support 48 only between the stowed and deployed positions). Such positive steps or other position-limiting features may further provide the weight-bearing support for supports 46, 48, such that fastener 56 serves only to prevent rotation of supports 46, 48 between the stowed and deployed positions. Various other modifications may be made to the components and mounting features of supports 46, 48, and all such modifications are deemed to be within the scope of the present disclosure.

Referring now to FIG. 7, the interface between support 46 and hand 28 is shown according to an exemplary embodiment (for clarity, support arm 50 has not been shown in FIG. 7). As shown in FIG. 7, extension 52 may include an upper collar portion 70, and arm 28 may include a lower collar portion 72. Upper collar portion 70 may rotate upon lower collar portion 72 and have one or more surfaces 78 that are positioned to interface with a raised portion 76 provided on lower collar portion 72 to limit the range of motion of extension 52 (and therefore, support 46) to a predetermined range of motion (e.g., 90 degrees, etc.). For example, as shown in FIG. 7, upper collar portion 70 and lower collar portion 72 are sized to provide a range of motion for support 46 (and, similarly, support 48) of approximately 90 degrees. Fastener 56 may be inserted through an aperture 74 in lower collar portion 72 and into one of apertures 58 to lock extension 52 in the deployed or stored position.

As discussed above, providing positive stop features such as upper collar portion 70 and lower collar portion 72 provides a reliable means for accommodating the loads that may be placed on supports 46, 48, and that may otherwise be supported by fastener 56. In this way, fastener 56 may only need to maintain supports 46, 48 in the proper position, with upper collar portion 70 and lower collar portion 72 providing the weight-bearing support for supports 46, 48.

It should be understood that the configuration of upper collar portion 70 and lower collar portion 72 is provided for purposes of illustration only, and that modifications may be made within the scope of this disclosure, such as reversing the relative positions of the upper and lower collar portions, adjusting the range of motion permitted by upper and lower collar portions 70, 72, and so on. Further, upper collar portion 70 and lower collar portion 72 may be fastened to arm 46 and hand 30, respectively, using any suitable means, including mechanical fasteners (e.g., screws, rivets, etc.), welding, and so on. All such modifications are deemed to be within the scope of the present disclosure.

As shown in the various exemplary embodiments herein, supports 46, 48 may be manually adjusted, positioned, and/or locked into a deployed or stored position. According to various alternative embodiments, supports 46, 48 may be remotely controlled via hydraulic, mechanical, electrical, or other means. In some embodiments, supports 46, 48 may be controlled from a control unit located in vehicle 10.

The tire manipulator shown and discussed herein is intended to provide advantages over typical tire handlers, by maintaining a tire in a generally vertical position should the tire slip relative to or come free from the tire handler. Such a feature assists in avoiding injury to operators and potential damage to equipment. In use, an operator wishing to move or manipulate tire 14 may first move extensions 20, 22 to an appropriate width for the tire. Extensions 20, 22 may then be moved into a position relative to tire 14 such that clamping members 32, 34 may engage treaded portion 68 of tire 14. Supports 46, 48 may then be moved from a stowed position and locked into a deployed position, as shown in FIG. 6. Clamping members 32, 34 may then be moved toward each other such that clamping members 32, 34 engage treaded portion 68. Tire manipulator 12 may then move or otherwise manipulate tire 14 as desired, after which tire 14 may be released from clamping members 32, 34, and supports 46, 48 may be moved from the deployed position back to the stowed position. According to various alternative embodiments, certain steps discussed herein may be omitted, re-ordered, etc.

It is important to note that the construction and arrangement of the tire manipulator as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present disclosure. The order or sequence of any process or method steps may be varied or resequenced according to alternative embodiments. Other substitutions, modifications, changes, and omissions may be made in the design, operating conditions, and arrangement of the exemplary embodiments, without departing from the scope of the present disclosure.

What is claimed is:

1. A tire manipulator comprising:
a base;
first and second extensions coupled to the base and configured to support a tire, each of the first and second extensions including a first end coupled to the base and a second end configured to support the tire; and
first and second supports movably coupled to the first and second extensions, respectively, the first and second supports being disposed between the first and second end of each of the first and second extensions;
wherein the first and second supports are positionable to prevent the tire from rotating relative to the first and second extensions toward the base.

2. The tire manipulator of claim 1, wherein the base is configured to be coupled to a vehicle.

3. The tire manipulator of claim 1, wherein each of the first and second extensions includes a first portion movably coupled to the base and a second portion movably coupled to the first portion.

4. The tire manipulator of claim 1, further comprising:
first and second clamping members coupled to the second end of each of the first and second extensions, respectively, each of the first and second clamping members including a clamping surface configured to engage a surface of the tire.

5. The tire manipulator of claim 4, wherein the clamping surface of each of the first and second clamping members is configured to engage a treaded surface of the tire, and wherein the first and second supports are configured to engage a sidewall of the tire.

6. The tire manipulator of claim 1, wherein each of the first and second supports includes a mounting shaft that extends into a corresponding aperture provided in each of the first and second extensions.

7. The tire manipulator of claim 6, wherein each of the first and second supports is rotatable to a first position wherein the first and second supports prevent the tire from rotating toward the base, and to a second position wherein the tire is permitted to rotate toward the base.

8. The tire manipulator of claim 1, wherein each of the first and second supports is selectively lockable in each of the first and second positions.

9. A tire manipulator comprising:
a base; and
first and second extensions coupled to the base and configured to support a tire, the tire having a treaded portion and a sidewall extending from the treaded portion, each of the first and second extensions including:
an arm member coupled to the base;
a hand member coupled to the arm member;
a clamping member extending from the hand member and configured to engage the treaded portion of the tire; and
a fall-back support coupled to the hand member and configurable to extend from the hand member to engage the sidewall and prevent rotation of the tire toward the base.

10. The tire manipulator of claim 9, wherein the base is configured to be coupled to at least one of a vehicle and an articulated crane.

11. The tire manipulator of claim 9, wherein the fall-back support is movably coupled to the hand member and is moveable between a first position and a second position, wherein the fall-back support prevents rotation of the tire toward the base when in the first position, and wherein the fall-back support permits rotation of the tire toward the base when in the second position.

12. The tire manipulator of claim 11, wherein the fall back support includes a first collar member configured to engage a second collar member provided on the hand member, and wherein the first and second collar members limit the fall back support to a range of motion defined by the first and second positions.

13. The tire manipulator of claim 11, wherein the fall-back support includes a generally cylindrical member configured to engage a correspondingly shaped aperture defined in the hand member to rotatably couple the fall-back support to the hand member.

14. The tire manipulator of claim 11, wherein the fall-back support extends in a parallel direction to the sidewall of the tire when in the first position.

15. A maintenance vehicle comprising:
a vehicle body; and
a tire manipulator coupled to the vehicle body and configured to manipulate a tire, the tire manipulator including:
a base portion;
a pair of extensions extending from the base portion, each extension including a gripping surface configured to engage a surface of the tire; and
a pair of fall-back supports disposed between the base portion and the tire and positionable to prevent the tire from rotating toward the base portion in the event of slippage between the gripping surfaces and the surface of the tire.

16. The maintenance vehicle of claim 15, wherein the base portion is moveable relative to the vehicle body.

17. The maintenance vehicle of claim 15, wherein each extension includes a first portion coupled to the base portion and a second portion coupled to the first portion and including the gripping surface.

18. The maintenance vehicle of claim 15, wherein each of the extensions includes a top surface and a bottom surface, and the fall-back supports extend from the top surface of each extension.

19. The maintenance vehicle of claim 15, wherein each of the fall-back supports engages a corresponding aperture in each of the extensions to rotatably couple each of the fall-back supports to one of the extensions.

20. The maintenance vehicle of claim 15, wherein each of the fall-back supports is selectively lockable in a plurality of positions.
